(19) United States
(12) Patent Application Publication
(10) Pub. No.: US 2025/0008296 A1
(43) Pub. Date: Jan. 2, 2025

(54) APPARATUSES AND COMMUNICATION NETWORKS FOR DEVICE INTERACTION AND USER REPORTING

(71) Applicant: Weavix, Inc., Wichita, KS (US)

(72) Inventors: Benjamin BURRUS, Wichita, KS (US); Kevin TURPIN, Wichita, KS (US); Seth PHILLIPS, Overland Park, KS (US)

(21) Appl. No.: 18/757,002

(22) Filed: Jun. 27, 2024

Related U.S. Application Data
(60) Provisional application No. 63/511,096, filed on Jun. 29, 2023.

(51) Int. Cl. H04W 4/021; G06Q 10/0631; H04R 1/02; H04W 4/70

(52) U.S. Cl. CPC H04W 4/021; G06Q 10/0631; H04W 4/70; H04R 1/028; H04R 2499/15

(57) ABSTRACT

Methods, apparatuses, and systems for device tracking and geofencing reporting are disclosed herein. An apparatus (e.g., smart radio) carried by a worker includes location tracking and/or machine-to-machine communication components and a speaker. A machine in a work facility that does not otherwise include local, short-range reporting apparatus (e.g., a speaker) is equipped with a sensor suite configured to detect issues therewith. As a worker carrying a smart radio walks by a machine with a detected issue requiring repair or maintenance, the smart radio issues an auditory notification describing the issue, which enables the worker to stop and address the issue while they are in the local area of the machine. The smart radio thus operates as a speaker for the machine. Prior to issuing the auditory notification, the smart radio and/or cloud computing system determines whether the worker working proximate to the machine has relevant skills and/or equipment to effect repairs or maintenance on the machine based on worker profiles logged in to the smart radio that include descriptions of the worker's role, skills and/or experience.

### CROSS-REFERENCE TO RELATED APPLICATIONS

This application claims the benefit of U.S. Provisional Patent Application No. 63/511,096, filed Jun. 29, 2023, which is incorporated by reference herein in its entirety.

### BACKGROUND

Traditional methods to monitor facilities are used to perform inspections in particular environments. Identifying issues with machinery is difficult. Typically, a frontline worker must manually inspect a machine or sensors in the machine and report to a central hub, which must dispatch a frontline worker to the machine. Where worksites are large, dispatch from a central hub can be highly inefficient. Frontline workers are typically disallowed from carrying smartphones, tablets, or portable computers on site. However, traditional methods and systems for communication within, and monitoring of, manufacturing and construction facilities sometimes have inadequate risk management and safeguards, lack an efficient structure, or can suffer from unrealistic risk management expectations or poor production forecasting.

### BRIEF DESCRIPTION OF THE DRAWINGS

FIG. 1 is a block diagram illustrating an example architecture for an apparatus implementing device tracking using geofencing, in accordance with one or more embodiments.

FIG. 2A is a drawing illustrating an example environment for apparatuses and communication networks for device tracking and geofencing, in accordance with one or more embodiments.

FIG. 2B is a flow diagram illustrating an example process for generating a work experience profile using apparatuses and communication networks for device tracking and geofencing, in accordance with one or more embodiments.

FIG. 3 is a drawing illustrating an example facility using apparatuses and communication networks for device tracking and geofencing, in accordance with one or more embodiments.

FIG. 4 is a diagram illustrating geofencing and geofenced-based communication within a facility or worksite, in accordance with one or more embodiments.

FIG. 5 is a flow diagram illustrating an example process for response-controlled communications for geofenced areas, in accordance with one or more embodiments.

FIG. 6 is a block diagram illustrating an example machine learning (ML) system, in accordance with one or more embodiments.

FIG. 7 is a block diagram illustrating an example computer system, in accordance with one or more embodiments.

### DETAILED DESCRIPTION

The embodiments disclosed herein describe methods, apparatuses, and systems for device tracking and machine interfaces. Construction, manufacturing, repair, utility, resource extraction and generation, and healthcare industries, among others, rely on real-time monitoring and tracking of frontline workers, individuals, inventory, and assets such as infrastructure and equipment. In some embodiments, a portable and/or wearable apparatus, such as a smart radio, a smart camera, or a smart environmental sensor records information, downloads information, or communicates with other apparatuses and/or equipment. Some embodiments of the present disclosure provide lightweight and low-power apparatuses that are worn or carried by a worker and used to monitor information in the field or track the worker, at least for communication and equipment interface. The disclosed apparatuses provide alerts, locate resources for workers, and provide workers with access to communication networks. The wearable apparatuses disclosed enable worker compliance and provide assistance with operator tasks.

In some embodiments, the smart radio worn by workers receives communication from nearby machines and equipment. The communications cause the smart radio to emit status notifications and alerts regarding the nearby machine. For example, a sensor equipped to a gas boiler detects that the boiler is running hotter than specification, perhaps emitting a higher degree of greenhouse gases than regulation. A frontline worker is passing by wearing a smart radio. As the worker passes by, the boiler communicates with the smart radio and causes the smart radio to emit an auditory notification: “Boiler #2 is running 10 degrees hotter than specification.” Rather than wait for a central hub to dispatch a worker, the worker passing by may inspect the boiler and implement any repairs or modifications to address the issue. Additionally, the worker did not have to notice the issue through any manual inspection; rather, the notification was sent while the worker was in the area.

In various embodiments, the system employs different methods of discretion in notifying workers passing by. The smart radios include login information for the workers and identify those workers. As a worker passes by, the system evaluates whether the worker is qualified to operate or effect repairs on the relevant machine and does not alert unqualified workers. Further, some workers are on priority tasks and issuing bothersome notifications as they pass by is disruptive rather than helpful. Where the smart radio integrates with the dispatch system, the smart radio carries the worker's current duties as metadata to be queried prior to issuing machine notifications.

Disclosed smart radios enable workers to view other workers' credentials and roles such that participants know the level of expertise present. The systems further enable the location of workers who are currently out in the field using a facility map that is populated by information from smart radios, smart cameras, or smart sensors.

Industrial equipment is a significant contributor to the generation of greenhouse gas emissions. The disclosed smart radios improve efficiency to repair potentially environmentally hazardous conditions on industrial equipment. The improvements in efficiency come from both addressing the issues more quickly and from reducing the amount of driving (e.g., using internal combustion engines) around work sites that may be many square miles large. First, as noted above, malfunctioning industrial equipment can be a significant contributor to the generation of greenhouse gas emissions—improving the rate at which these hazardous conditions are repaired reduces the amount of harmful gas (e.g., greenhouse gas) that is released into the environment. Secondly, by making use of local workers rather than dispatched workers, additional transport trips, that generate additional emissions, become unnecessary. As such, the disclosed technology reduces and/or prevents greenhouse gas emissions.

Among other benefits and advantages, the disclosed systems provide greater visibility compared to traditional methods within a confined space of a facility for greater workforce optimization. The digital time logs for entering and exiting a facility measure productivity levels on an individual basis and provide insights into how the weather at outdoor facilities in different geographical locations affects workers. The time tracking technology enables visualization of the conditions a frontline worker is working under while keeping the workforce productive and protected. In addition, the advantages of the machine learning (ML) modules in the disclosed systems include the use of shared weights in convolutional layers, which means that the same filter (weights bank) is used for each node in a layer. The weight structure both reduces memory footprint and improves performance for the system.

The smart radio embodiments disclosed that include Radio over Internet Protocol (RoIP) provide the ability to use an existing Land Mobile Radio (LMR) system for communication between workers, allowing a company to bridge the gap that occurs through the process of digitally transforming its systems. Communication is thus more open because legacy systems and modern apparatuses communicate with fewer barriers, the communication range is not limited by the radio infrastructure because the smart radios use the Internet, and costs are reduced for a company to provide communication apparatuses to their workforce by obviating more-expensive, legacy radios. The smart apparatuses enable workers to provide field observations to report safety issues in real time to drive operational performance. The apparatuses enable mass notifications to rapidly relay information to a specific subgroup, provide real-time updates for repair, and transmit accurate location pins.

The smart apparatuses disclosed reduce the need for workers to wear multiple, cumbersome, non-integrated, and potentially distractive devices into one user-friendly, comfortable, and cost-effective smart device. Advantages of the smart radio disclosed include ease of use for carrying in the field during extended durations due to its smaller size, relatively low power consumption, and integrated power source. The smart radio is sized to be small and lightweight enough to be regularly worn by a worker. The modular design of the smart radio disclosed enables quick repair, refurbishment, or replacement.

Embodiments of the present disclosure will be described more thoroughly from now on with reference to the accompanying drawings. Like numerals represent like elements throughout the several figures in which example embodiments are shown. However, embodiments of the examples are embodied in many different forms and should not be construed as limited to the embodiments set forth herein. The examples set forth herein are non-limiting examples and are merely examples among other possible examples.

### Smart Radio

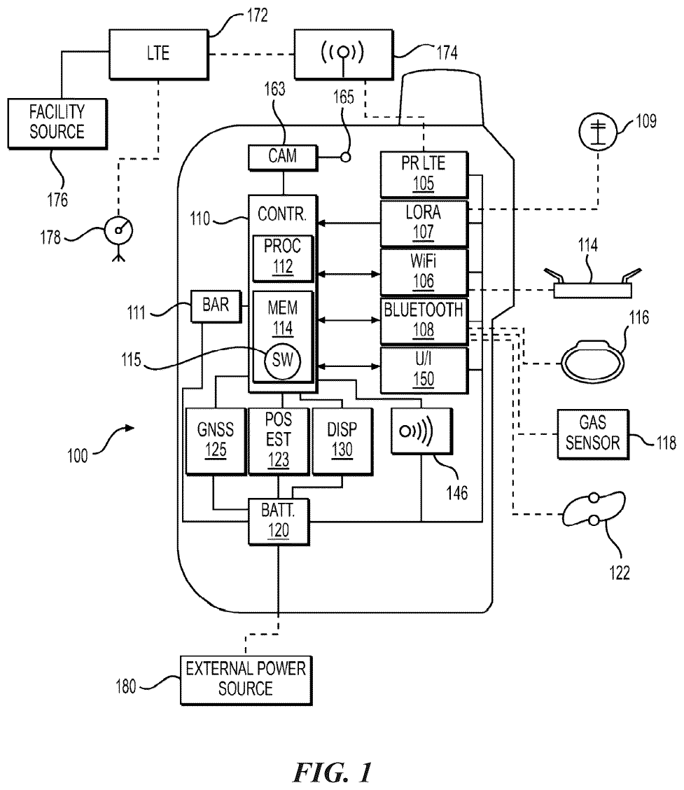

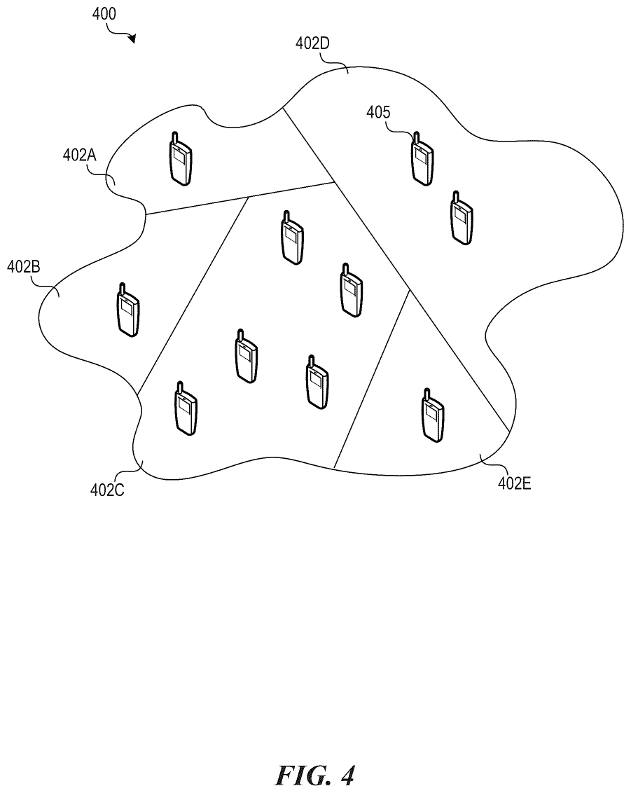

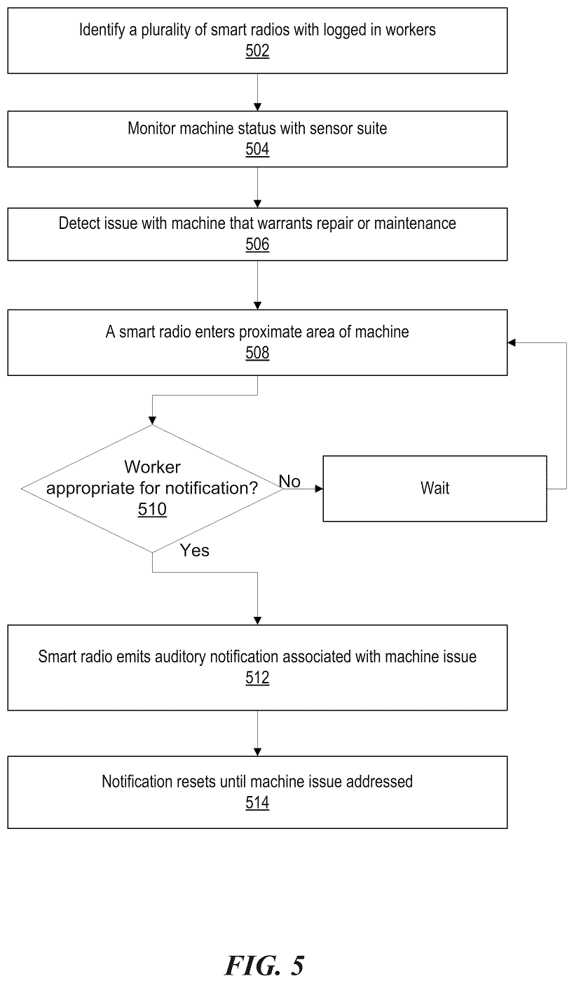

FIG. 1 is a block diagram illustrating an example architecture for an apparatus 100 implementing device tracking using geofencing, in accordance with one or more embodiments. The apparatus 100 is implemented using components of the example computer system illustrated and described in more detail with reference to subsequent figures. In embodiments, the apparatus 100 is used to execute the ML system illustrated and described in more detail with reference to subsequent figures. The architecture shown by FIG. 1 is incorporated into a portable wireless apparatus 100, such as a smart radio, a smart camera, a smart watch, a smart headset, or a smart sensor. FIGS. 4-5 show different views of an exemplary smart radio that includes the architecture of the apparatus 100 shown in FIG. 1. Likewise, different embodiments of the apparatus 100 include different and/or additional components and are connected in different ways.

The apparatus 100 shown in FIG. 1 includes a controller 110 communicatively coupled electronically, either directly or indirectly, to a variety of wireless communication arrangements, a position estimating component 123 (e.g., a dead reckoning system) that estimates current position using inertia, speed, and intermittent known positions received from a position tracking component 125, which, in embodiments, is a Global Navigation Satellite System (GNSS) component, a display screen 130, an optional audio device 146, a user-input device 150, and a dual built-in camera 165 (another camera, 163 is on the other side of the device). A battery 120 is electrically coupled with a private Long-Term Evolution (LTE) wireless communication device 105, a Wi-Fi subsystem 106, a low-power wide area network (LPWAN), for example, long-range (LoRa) protocol subsystem 107, Bluetooth subsystem 108, barometer 111, audio device 146, user-input device 150, and built-in camera 163 for providing electrical power. Battery 120 is electrically and communicatively coupled with controller 110 for providing electrical power to controller 110 and enabling controller 110 to determine a status of battery 120 (e.g., a state of charge). In embodiments, battery 120 is a removable, rechargeable battery.

Controller 110 is, for example, a computer having a memory 114, including a non-transitory storage medium for storing software 115, and a processor 112 for executing instructions of the software 115. In some embodiments, controller 110 is a microcontroller, a microprocessor, an integrated circuit (IC), or a system-on-a-chip (SoC). Controller 110 includes at least one clock capable of providing time stamps and displaying time via display screen 130. The at least one clock is updatable (e.g., via the user interface 150, a global positioning system (GPS) navigational device, the position tracking component 125, the Wi-Fi subsystem 106, the LoRa subsystem 107, the server 176, or a combination thereof).

In embodiments, the apparatus 100 (e.g., implemented as a smart radio) communicates with a worker ID badge and a charging station using near-field communication (NFC) technology. An NFC-enabled device, such as a smart radio, also operates like an NFC tag or card, allowing a worker to perform transactions such as clocking in for the day at a worksite or facility, making payments, clocking out for the day, or logging in to a computer system of the facility. The smart radio communicates with the charging station using NFC in one or both directions.

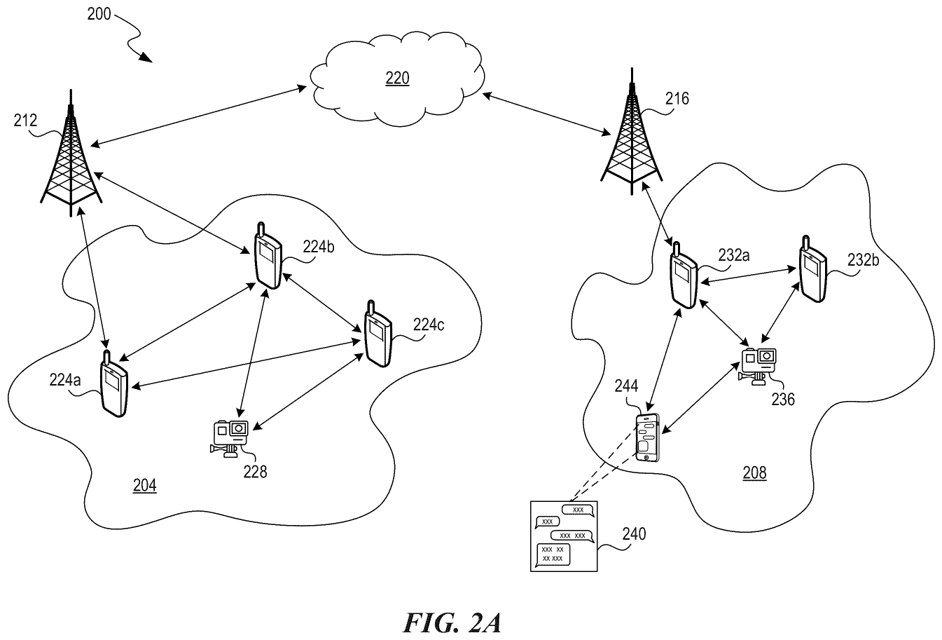

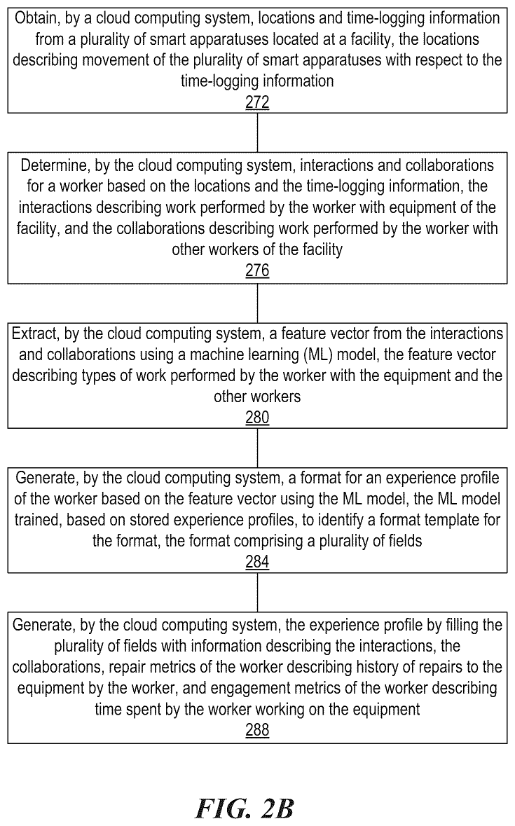

Workers entering a facility carry or wear an identification (ID) badge that has an NFC tag (and optionally an RFID tag) embedded in the badge. The NFC tag in the worker's ID badge stores personal information of the worker. Examples include name, employee or contractor serial number, login credentials, emergency contact(s), address, shifts, roles (e.g., crane operator), any other professional or personal information, or a combination thereof. When workers arrive for a shift, they pick a smart radio up off the charging station and tap their ID badge to the smart radio. The NFC tag in the ID badge communicates with an NFC module in the smart radio to log the worker into the smart radio and log/clock the worker into the workday. In FIG. 2A, the worker's personal information is stored in the cloud computing system 220.

Given that the workers' roles are “known” to the smart radio, communication with local machines is informed by those roles. For example, where the worker is emergency or medical staff, there is little point in alerting that worker to machine status messages. Conversely, a technician or machine operator would receive status notifications to relevant local machinery.

In some embodiments, when a smart radio is picked up off a charging station by a worker arriving at the facility, the smart radio operates as a time clock to record the start time for the worker at the facility. In some embodiments, the worker logs into the facility system using a touchscreen or buttons of the smart radio.

The cloud computing system 220 stores, manages, and updates shifts, contacts, and roles for each worker, project, and facility. A shift refers to a planned, set period of time during which the worker (optionally with a group of other workers) performs their duties. The worker has one or more roles (e.g., lathe operator, lift supervisor) for the same or different shifts. In some embodiments, the cloud computing system 220 keeps track of tools or equipment held by the worker (e.g., via Bluetooth tags on the equipment in proximity to the worn smart radio).

The cloud computing system 220 thus stores, manages, and updates shifts, contacts, and roles for each worker, project, and facility. The information is updated based in part on time logging information received from the smart radios and other smart apparatuses (as shown by FIG. 2A). The cloud computing system 220 updates each smart radio with the information (on roles and contacts) needed for a shift when a worker clocks in using the radio.

In some embodiments, roles are assigned on a tiered basis. For example, Alice has roles assigned to her as an individual, as connected to the contract she is working, and as connected to her employer. Each of those tiers operates identity management within the cloud computing system 220. Each user frequently will work with others they have never met before and does not have the contact information thereto. Frontline workers tend to collaborate across employers or contracts. Based on tiered, assigned roles, the relevant contact information for workers on a given task/job is shared therebetween. “Contact information” as facilitated by the smart radio is governed by the user account in each smart radio (e.g., as opposed to a phone number connected to a cellular phone).

In embodiments, the smart radio and the cloud computing system 220 have geofencing capabilities. The smart radio allows the worker to clock in and out only when they are within a particular Internet geolocation. A geofence refers to a virtual perimeter for a real-world geographic area, (e.g., a portion of a facility). For example, a geofence is dynamically generated for the facility (as in a radius around a point location) or matched to a predefined set of boundaries (such as construction zones or refinery boundaries, or around specific equipment). A location-aware device (e.g., the position tracking component 125 and the position estimating component 123) of the smart radio entering or exiting a geofence triggers an alert to the smart radio, as well as messaging to a supervisor's device (e.g., the text messaging display 240 illustrated in FIG. 2A), the cloud computing system 220, or a local server. The information, including a location and time, is sent to the cloud computing system 220. In embodiments, the machine learning system, illustrated and described in more detail with reference to subsequent figures, is used to trigger alerts, for example, using features based on equipment malfunctions or operational hazards as input data.

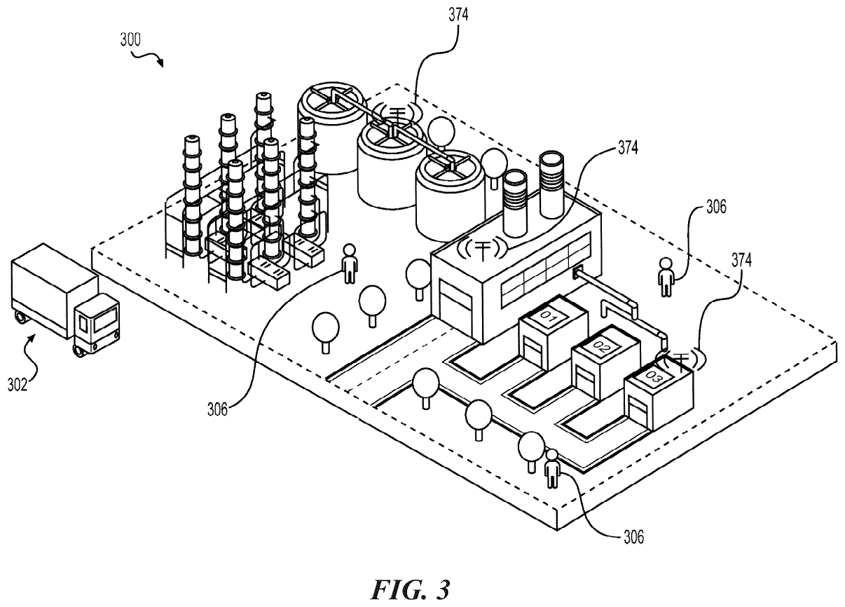

The wireless communications arrangement includes a cellular subsystem 105, a Wi-Fi subsystem 106, the optional LPWAN/LoRa network subsystem 107 wirelessly connected to a LPWAN network 109, and a Bluetooth subsystem 108, all enabling sending and receiving. Cellular subsystem 105, in embodiments, enables the apparatus 100 to communicate with at least one wireless antenna 174 located at a facility (e.g., a manufacturing facility, a refinery, or a construction site). For example, the wireless antennas 174 are permanently installed or temporarily deployed at the facility. Example wireless antennas 374 are illustrated and described in more detail with reference to FIG. 3.

In embodiments, a cellular edge router arrangement 172 is provided for implementing a common wireless source. A cellular edge router arrangement 172 (sometimes referred to as an “edge kit”) is usable to include a wireless cellular network into the Internet. In embodiments, the LPWAN network 109, the wireless cellular network, or a local radio network is implemented as a local network for the facility usable by instances of the apparatus 100, for example, the local network 204 illustrated and described in more detail with reference to FIG. 2A. For example, the cellular type can be 2G, 3G, 4G, LTE, 5G, etc. The edge kit 172 is typically located near a facility's primary Internet source 176 (e.g., a fiber backhaul or other similar device).

Alternatively, a local network of the facility is configured to connect to the Internet using signals from a satellite source, transceiver, or router 178, especially in a remotely located facility not having a backhaul source, or where a mobile arrangement not requiring a wired connection is desired. More specifically, the satellite source plus edge kit 172 is, in embodiments, configured into a vehicle or portable system. In embodiments, the cellular subsystem 105 is incorporated into a local or distributed cellular network operating on any of the existing 88 different Evolved Universal Mobile Telecommunications System Terrestrial Radio Access (EUTRA) operating bands (ranging from 700 MHz up to 2.7 GHz). For example, the apparatus 100 can operate using a duplex mode implemented using time division duplexing (TDD) or frequency division duplexing (FDD).

The Wi-Fi subsystem 106 enables the apparatus 100 to communicate with an access point 114 capable of transmitting and receiving data wirelessly in a relatively high-frequency band. In embodiments, the Wi-Fi subsystem 106 is also used in testing the apparatus 100 prior to deployment. A Bluetooth subsystem 108 enables the apparatus 100 to communicate with a variety of peripheral devices, including a biometric interface device 116 and a gas/chemical detection device 118 used to detect noxious gases. In embodiments, the biometric and gas-detection devices 116 and 118 are alternatively integrated into the apparatus 100. In embodiments, numerous other Bluetooth devices are incorporated into the apparatus 100.

As used herein, the wireless subsystems of the apparatus 100 include any wireless technologies used by the apparatus 100 to communicate wirelessly (e.g., via radio waves) with other apparatuses in a facility (e.g., multiple sensors, a remote interface, etc.), and optionally with the cloud/Internet for accessing websites, databases, etc. The wireless subsystems 105, 106, and 108 are each configured to transmit/receive data in an appropriate format, for example, in Institute of Electrical and Electronics Engineers (IEEE) 802.11, 802.15, 802.16 Wi-Fi standards, Bluetooth standard, WinnForum Spectrum Access System (SAS) test specification (WINNF-TS-0065), and across a desired range. In embodiments, multiple apparatuses 100 are connected to provide data connectivity and data sharing across the multiple apparatuses 100. In embodiments, the shared connectivity is used to establish a mesh network.

The position tracking component 125 and the position estimating component 123 operate in concert. In embodiments, the position tracking component 125 is a GNSS (e.g., GPS) navigational device that receives information from satellites and determines a geographical position based on the received information. The position tracking component 125 is used to track the location of the apparatus 100. In embodiments, a geographic position is determined at regular intervals (e.g., every five seconds) and the position in between readings is estimated using the position estimating component 123.

GPS position data is stored in memory 114 and uploaded to server 170 at regular intervals (e.g., every minute). In embodiments, the intervals for recording and uploading GPS data are configurable. For example, if the apparatus 100 is stationary for a predetermined duration, the intervals are ignored or extended, and new location information is not stored or uploaded. If no connectivity exists for wirelessly communicating with server 170, location data is stored in memory 114 until connectivity is restored, at which time the data is uploaded, then deleted from memory 114. In embodiments, GPS data is used to determine latitude, longitude, altitude, speed, heading, and Greenwich mean time (GMT), for example, based on instructions of software 115 or based on external software (e.g., in connection with server 176). In embodiments, position information is used to monitor worker efficiency, overtime, compliance, and safety, as well as to verify time records and adherence to company policies.

In some embodiments, a Bluetooth tracking arrangement using beacons is used for position tracking and estimation. For example, Bluetooth component 108 receives signals from Bluetooth Low Energy (BLE) beacons. The BLE beacons are located about the facility similar to the example wireless antennas 374 shown by FIG. 3. The controller 110 is programmed to execute relational distancing software using beacon signals (e.g., triangulating between beacon distance information) to determine the position of the apparatus 100. Regardless of the process, the Bluetooth component 108 detects the beacon signals and the controller 110 determines the distances used in estimating the location of the apparatus 100.

In alternative embodiments, the apparatus 100 uses Ultra-Wideband (UWB) technology with spaced apart beacons for position tracking and estimation. The beacons are small, battery-powered sensors that are spaced apart in the facility and broadcast signals received by a UWB component included in the apparatus 100. A worker's position is monitored throughout the facility over time when the worker is carrying or wearing the apparatus 100. As described herein, location-sensing GNSS and estimating systems (e.g., the position tracking component 125 and the position estimating component 123) can be used to primarily determine a horizontal location. In embodiments, the barometer component is used to determine a height at which the apparatus 100 is located (or operate in concert with the GNSS to determine the height) using known vertical barometric pressures at the facility. With the addition of a sensed height, a full three-dimensional location is determined by the processor 112. Applications of the embodiments include determining if a worker is, for example, on stairs or a ladder, atop or elevated inside a vessel, or in other relevant locations.

An external power source 180 is optionally provided for recharging battery 120. In embodiments, the architecture of the apparatus 100 shown by FIG. 1 includes a connector that connects to the external power source 180.

In embodiments, display screen 130 is a touch screen implemented using a liquid-crystal display (LCD), an e-ink display, an organic light-emitting diode (OLED), or other digital display capable of displaying text and images. An example text messaging display 240 is illustrated in FIG. 2A. In embodiments, display screen 130 uses a low-power display technology, such as an e-ink display, for reduced power consumption. Images displayed using display screen 130 include, but are not limited to, photographs, video, text, icons, symbols, flowcharts, instructions, cues, and warnings. For example, display screen 130 displays (e.g., by default) an identification-style photograph of an employee who is carrying the apparatus 100 such that the apparatus 100 replaces a traditional badge worn by the employee. In another example, step-by-step instructions for aiding a worker while performing a task are displayed via display screen 130. In embodiments, display screen 130 locks after a predetermined duration of inactivity by a worker to prevent accidental activation via user-input device 150.

The audio device 146 optionally includes at least one microphone (not shown) and a speaker for receiving and transmitting audible sounds, respectively. Although only one speaker is shown existing in the architecture drawing of FIG. 1, it should be understood that in an actual physical embodiment, multiple speakers (and also microphones used for the purpose of noise cancellation) are utilized such that the apparatus 100 can adequately receive and transmit audio. In embodiments, the speaker has an output around 105 dB to be loud enough to be heard by a worker in a noisy facility. The speaker adjusts to ambient noise, for example, as the audio device 146 or a circuit driving the speaker samples the ambient noise, and then increases a volume of the output audio from the speaker such that the volume is greater than the ambient noise (e.g., 5 dB louder). In embodiments, a worker speaks commands to the apparatus 100. The microphone of the audio device 146 receives the spoken sounds and transmits signals representative of the sounds to controller 110 for processing.

In embodiments, the audio device 146 disseminates audible information to the worker via the speaker and receives spoken sounds via the microphone(s). The audible information is generated by the apparatus 100 based on data or signals received by the apparatus 100 (e.g., the smart camera 228 illustrated and described in more detail with reference to FIG. 2A) from the cloud computing system 220, an administrator, a nearby machine, or a local server. For example, the audible information includes instructions, reminders, cues, and/or warnings to the worker and is in the form of speech, bells, dings, whistles, music, or other attention-grabbing noises without departing from the scope hereof. In embodiments, one or more speakers of the apparatus 100 (e.g., the smart radio) are adapted to emit sounds from a front side, a back side, any of the other sides of the smart radio, or even multiple sides of the smart radio.

In some embodiments, the smart radio 100 pairs to nearby machines via a Bluetooth radio 108 and the machine transmits relevant data concerning the status and operation history of the machine. In some embodiments the Bluetooth radio 108 receives beacon signals from the nearby machinery via BLE protocol. These beacon signals are interpreted by the smart radio 100 and/or cloud computing system 220 as a number of predetermined notification types. Based on the notification type or data received through pairing, the smart radio 100 emits audible information to the worker via the speaker.

In some embodiments, machinery communicates directly with the cloud computing system 220, and using a cross-reference between the tracked location of a given smart radio 100, a known location of the machinery, status data of the machinery, and individual worker information (e.g., roles, current task, etc.), the cloud computing system 220 issues a notification to the smart radio 100 to emit audible information to the worker.

### Communication Network Features

FIG. 2A is a drawing illustrating an example environment 200 for apparatuses and communication networks for device tracking and geofencing, in accordance with one or more embodiments. The environment 200 includes a cloud computing system 220, cellular transmission towers 212, 216, and local networks 204, 208. Components of the environment 200 are implemented using components of the example computer system illustrated and described in more detail with reference to subsequent figures. Likewise, different embodiments of the apparatus 100 include different and/or additional components and are connected in different ways.

Smart radios 224, 232 and smart cameras 228, 236 are implemented in accordance with the architecture shown by FIG. 1. In embodiments, smart sensors implemented in accordance with the architecture shown by FIG. 1 are also connected to the local networks 204, 208 and mounted on a surface of a worksite, or worn or carried by workers. For example, the local network 204 is located at a first facility and the local network 208 is at a second facility. An example facility 300 is illustrated and described in more detail with reference to FIG. 3. In embodiments, each smart radio and other smart apparatus has two Subscriber Identity Module (SIM) cards, sometimes referred to as dual SIM. A SIM card is an IC intended to securely store an international mobile subscriber identity (IMSI) number and its related key, which are used to identify and authenticate subscribers on mobile telephony devices.

A first SIM card enables the smart radio 224a to connect to the local (e.g., cellular) network 204 and a second SIM card enables the smart radio 224a to connect to a commercial cellular tower (e.g., cellular tower 212) for access to mobile telephony, the Internet, and the cloud computing system 220 (e.g., to major participating networks such as Verizon™, AT&T™, T-Mobile™, or Sprint™). In such embodiments, the smart radio 224a has two radio transceivers, one for each SIM card. In other embodiments, the smart radio 224a has two active SIM cards, and the SIM cards both use only one radio transceiver. However, the two SIM cards are both active only as long as both are not in simultaneous use. As long as the SIM cards are both in standby mode, a voice call could be initiated on either one. However, once the call begins, the other SIM becomes inactive until the first SIM card is no longer actively used.

In embodiments, the local network 204 uses a private address space of IP addresses. In other embodiments, the local network 204 is a local radio-based network using peer-to-peer two-way radio (duplex communication) with extended range based on hops (e.g., from smart radio 224a to smart radio 224b to smart radio 224c). Hence, radio communication is transferred similarly to addressed packet-based data with packet switching by each smart radio or other smart apparatus on the path from source to destination. For example, each smart radio or other smart apparatus operates as a transmitter, receiver, or transceiver for the local network 204 to serve a facility. The smart apparatuses serve as multiple transmit/receive sites interconnected to achieve the range of coverage required by the facility. Further, the signals on the local networks 204, 208 are backhauled to a central switch for communication to the cellular towers 212, 216.

In embodiments (e.g., in more remote locations), the local network 204 is implemented by sending radio signals between smart radios 224. Such embodiments are implemented in less inhabited locations (e.g., wilderness) where workers are spread out over a larger work area that may be otherwise inaccessible to commercial cellular service. An example is where power company technicians are examining or otherwise working on power lines over larger distances that are often remote. The embodiments are implemented by transmitting radio signals from a smart radio 224a to other smart radios 224b, 224c on one or more frequency channels operating as a two-way radio. The radio messages sent include a header and a payload. Such broadcasting does not require a session or a connection between the devices. Data in the header is used by a receiving smart radio 224b to direct the “packet” to a destination (e.g., smart radio 224c). At the destination, the payload is extracted and played back by the smart radio 224c via the radio's speaker.

For example, the smart radio 224a broadcasts voice data using radio signals. Any other smart radio 224b within a range limit (e.g., 1 mile (mi), 2 mi, etc.) receives the radio signals. The radio data includes a header having the destination of the message (smart radio 224c). The radio message is decrypted/decoded and played back on only the destination smart radio 22c. If another smart radio 224b receives the radio signals that was not the destination radio, the smart radio 224b rebroadcasts the radio signals rather than decoding and playing them back on a speaker. The smart radios 224 are thus used as signal repeaters. The advantages and benefits of the embodiments disclosed herein include extending the range of two-way radios or smart radios 224 by implementing radio hopping between the radios.

In embodiments, the local network is implemented using RoIP. RoIP, is similar to Voice over IP (VoIP), but augments two-way radio communications rather than telephone calls. For example, RoIP is used to augment VoIP with PTT (Push-to-Talk). With RoIP, at least one node of a network is a radio (or a radio with an IP interface device, e.g., the smart radio 224a) connected via IP to other nodes (e.g., smart radios 224b, 224c) in the local network 204. The other nodes can be two-way radios but could also be softphone applications running on a smartphone (e.g., the smartphone 224, or some other communications device accessible over IP).

In embodiments, the local network 204 is implemented using Citizens Broadband Radio Service (CBRS). To enable CBRS, the controller 110 includes multiple computing and other devices, in addition to those depicted (e.g., multiple processing and memory components relating to signal handling, etc.). The controller 110 is illustrated and described in more detail with reference to FIG. 1. For example, the private network component 105 (illustrated and described in more detail with reference to FIG. 1) includes numerous components related to supporting cellular network connectivity (e.g., antenna arrangements and supporting processing equipment configured to enable CBRS). The use of CBRS Band 48 (from 3550 MHz to 3700 MHz), in embodiments, provides numerous advantages. For example, the use of Band 48 provides longer signal ranges and smoother handovers. The use of CBRS Band 48 supports numerous smart radios 224 and smart camera 228 at the same time. A smart apparatus is therefore sometimes referred to as a Citizens Broadband Radio Service Device (CBSD).

In alternative embodiments, the Industrial, Scientific, and Medical (ISM) radio bands are used instead of CBRS Band 48. It should be noted that the particular frequency bands used in executing the processes herein could be different, and that the aspects of what is disclosed herein should not be limited to a particular frequency band unless otherwise specified (e.g., 4G-LTE or 5G bands could be used). In embodiments, the local network 204 is a private cellular (e.g., LTE) network operated specifically for the benefit of the facility. An example facility 300 implementing a private cellular network using wireless antennas 374 is illustrated and described in more detail with reference to FIG. 3. Only authorized users of the smart radios 224 have access to the local network 204. For example, the network 204 uses the 900 MHz spectrum. In another example, the local network 204 uses 900 MHz for voice and narrowband data for LMR communications, 900 MHz broadband for critical wide area, long-range data communications, and CBRS for ultra-fast coverage of smaller areas of the facility, such as substations, storage yards, and office spaces.

In embodiments, the communication systems disclosed herein mitigate the network bottleneck problem when larger groups of workers are working in or congregating in a localized area of the facility. When a large number of workers are gathered in one area, the smart radios 224 they carry or wear create too much demand for cellular networks or the cellular tower 212 to handle. To solve the problem, in embodiments, the cloud computing system 220 is configured to identify when a large number of smart radios 224 are located in proximity to each other.

In embodiments, the cloud computing system 220 anticipates where congestion is going to occur for the purpose of placing additional access points in the area. For example, the cloud computing system uses the ML system to predict where congestion is going to occur based on bottleneck history and previous location data for workers. An example of network chokepoints are facility entry points where multiple workers arrive in close succession and clock in. The cloud computing system 220 accounts for congestion at such entry points by including additional access points at such locations. The cloud computing system 220 configures each smart radio 224a to relay data in concert with the other smart radios 224b, 224c. By timing the transmissions of each smart radio 224a, the radio waves from the cellular tower 212 arrive at a desired location, i.e., the desired smart radio 224a, at a different point in time than the point in time the radio waves from the cellular tower 212 arrive at a different smart radio 224b. Simultaneously, the phased radio signals are overlaid to communicate with other smart radios 224c, mitigating the bottleneck.

The cloud computing system 220 delivers computing services—including servers, storage, databases, networking, software, analytics, and intelligence—over the Internet (“the cloud”) to offer faster innovation, flexible resources, and economies of scale. FIG. 2A depicts an exemplary high-level, cloud-centered network environment 200 otherwise known as a cloud-based system. Referring to FIG. 2A, it can be seen that the environment centers around the cloud computing system 220 and the local networks 204, 208. Through the cloud computing system 220, multiple software systems are made to be accessible by multiple smart radio apparatuses 224, 232, smart cameras 228, 236, as well as more standard devices (e.g., a smartphone 244 or a tablet) each equipped with local networking and cellular wireless capabilities. Each of the apparatuses 224, 228, 244, although diverse, embody the architecture of apparatus 100 shown by FIG. 1, but are distributed to different kinds of users or mounted on surfaces of the facility. For example, the smart radio 224a is worn by employees or independently contracted workers at a facility. The CBRS-equipped smartphone 244 is utilized by an on or offsite supervisor. The smart camera 228 is utilized by an inspector or another person wanting to have improved display or other options. Regardless, it should be recognized that numerous apparatuses are utilized in combination with an established cellular network (e.g., CBRS Band 48 in embodiments) to provide the ability to access the cloud software applications from the apparatuses (e.g., smart radio apparatuses 224, 232, smart cameras 228, 236, smartphone 244).

In embodiments, the cloud computing system 220 and local networks 204, 208 are configured to send communications to the smart radios 224, 232 or smart cameras 228, 236 based on analysis conducted by the cloud computing system 220. The communications enable the smart radio 224 or smart camera 228 to receive warnings, etc., generated as a result of analysis conducted. The employee-worn smart radio 224a (and possibly other devices including the architecture of apparatus 100, such as the smart cameras 228, 236) are used along with the peripherals shown in FIG. 1 to accomplish a variety of objectives. For example, workers, in embodiments, are equipped with a Bluetooth enabled gas-detection smart sensor, implemented using the architecture shown in FIG. 1. The smart sensor detects the existence of a dangerous gas, or gas level. By connecting through the smart radio 224a or directly to the local network 204, the readings from the smart sensor are analyzed by the cloud computing system 220 to implement a course of action due to sensed characteristics of toxicity. The cloud computing system 220 sends an alert out to the smart radio 224 or smart camera 228, and thus a worker, for example, uses speaker 146 or alternative notification means to alert the worker so that they can avoid danger. The speaker 146 is illustrated and described in more detail with reference to FIG. 1.

### Machine-Defined Interactions

The cloud computing system 220 uses data received from the smart radio apparatuses 224, 232 and smart cameras 228, 236 to track and monitor machine-defined interactions and collaborations of workers based on locations worked, times worked, analysis of video received from the smart cameras 228, 236, etc. An “interaction” describes a type of work activity performed by the worker. An interaction is measured by the cloud computing system 220 in terms of at least one of a start time, a duration of the activity, an end time, an identity (e.g., serial number, employee number, name, seniority level, etc.) of the worker performing the activity, an identity of the equipment(s) used by the worker, or a location of the activity. In embodiments, an interaction is measured by the cloud computing system 220 in terms of a vector (e.g., [time period 1, equipment location 1; time period 2, equipment location 2; time period 3, equipment location 3]). For example, a first interaction describes time spent operating a particular machine (e.g., a lathe, a tractor, a boom lift, a forklift, a bulldozer, a skid steer loader, etc.), performing a particular task, or working at a particular type of facility (e.g., an oil refinery).

A smart radio 224a carried or worn by a worker would track that the position of the smart radio 224a is in proximity to or coincides with a position of the particular machine. Example tasks include operating a machine to stamp sheet metal parts for manufacturing side frames, doors, hoods, or roofs of automobiles, or welding, soldering, screwing, or gluing parts onto an automobile, all for a particular time period, etc. A lathe, lift, or other equipment would have sensors (e.g., smart camera 228 or other peripheral devices) that log times when the smart radio 224a is in proximity to the equipment and send that information to the cloud computing system 220.

In an example, a smart camera 228 mounted at a stamping shop in an automobile factory captures video of a worker working in the stamping shop and performs facial recognition or equipment recognition (e.g., using computer vision elements of the ML system illustrated and described in more detail with reference to subsequent figures). The smart camera 228 sends the start time, duration of the activity, end time, identity (e.g., serial number, employee number, name, seniority level, etc.) of the worker performing the activity, identity of the equipment(s) used by the worker, and location of the activity to the cloud computing system 220 for generation of one or more interaction(s).

The cloud computing system 220 also has a record of what a particular worker is supposed to be working on or is assigned to for the start time and duration of the activity. The cloud computing system 220 compares the interaction(s) computed with the planned shifts of the worker to signal mismatches, if any. An example interaction describes work performed at a particular geographic location (e.g., on an offshore oil rig or on a mountain at a particular altitude). The interaction is measured by the cloud computing system 220 in terms of at least the location of the activity and one of a duration of the activity, an identity of the worker performing the activity, or an identity of the equipment(s) used by the worker. In embodiments, the machine learning system is used to detect and track interactions, for example, by extracting features based on equipment types or manufacturing operation types as input data. For example, a smart sensor mounted on the oil rig transmits to and receives signals from a smart radio 224a carried or worn by a worker to log the time the worker spends at a portion of the oil rig.

A “collaboration” describes a type of group activity performed by a worker, for example, a group of construction workers working together in a team of two or more in an automobile paint facility, layering a chemical formula in a construction site for protection against corrosion and scratches, or installing an engine into a locomotive, etc. A collaboration is measured by the cloud computing system 220 in terms of at least one of a start time, a duration of the activity, an end time, identities (e.g., serial numbers, employee numbers, names, seniority levels, etc.) of the workers performing the activity, an identity of the equipment(s) used by the workers, or a location of the activity. In embodiments, a collaboration is measured by the cloud computing system 220 in terms of a vector (e.g., [time period 1, equipment location 1, worker identities 1; time period 2, equipment location 2, worker identities 2; time period 3, equipment location 3, worker identities 3]).

Collaborations are detected and monitored using location tracking (as described in more detail with reference to FIG. 1) of multiple smart apparatuses. For example, the cloud computing system 220 tracks and records a specific collaboration based on determining that two or more smart radios 224 were located in proximity to one another within a specific geofence associated with a particular worksite for a predetermined period of time. For example, a smart radio 224a transmits to and receives signals from other smart radios 224b, 224c carried or worn by other workers to log the time the worker spends working together in a team with the other workers.

In embodiments, a smart camera 228 mounted at a paint facility captures video of the team working in the facility and performs facial recognition (e.g., using the ML system). The smart camera 228 sends the location information to the cloud computing system 220 for generation of collaborations. Examples of data downloaded to the smart radios 224 to enable monitoring of collaborations include software updates, device configurations (e.g., customized for a specific operator or geofence), location save interval, upload data interval, and a web application programming interface (API) server uniform resource locator (URL). In embodiments, the machine learning system, illustrated and described in more detail with reference to FIG. 4, is used to detect and track interactions (e.g., using features based on geographical locations or facility types as input data).

In embodiments, the cloud computing system 220 determines a “response time” metric for a worker. The response time refers to the time difference between receiving a call to report to a given task and the time of arriving at a geofence associated with the task. To determine the response time, the cloud computing system 220 obtains and analyzes the time the call to report to the given task was sent to a smart radio 224a of the worker from the cloud computing system 220, a local server, or a supervisor's device (e.g., smart radio 224b). The cloud computing system 220 obtains and analyzes the time it took the smart radio 224a to move from an initial location to a location associated with the geofence.

In some embodiments, the response time is compared against an expected time. Expected time is based on trips originating from a location near the starting location for the worker (e.g., from within a starting geofenced area, or a threshold distance) and ending at the geofence associated with the task, or a regional geofence that the task occurs within. Embodiments that make use of a machine learning model identify similar historical journeys as a basis of comparison.

In an example, the cloud computing system 220 determines a “repair metric” for a worker and a particular type of equipment (e.g., a power line, etc.) For example, a repair metric identifies how frequently repairs by a given individual were effective. Effectiveness of repairs is machine observable based on a length of time a given object remains functional as compared to an expected time of functionality (e.g., a day, a few months, a year, etc.). After a worker is called to repair a given object, a timer begins to run. The timer is ended by either of a predetermined period expiring (e.g., expected usable life of repairs) or an additional worker being called to repair that same object.

Thus, where a second worker is called out to fix the same object before the expected usable life of the repair has expired, the original worker is assumed to have done a poor job on the repair and their respective repair metric suffers. In contrast, so long as a second worker has not been called out to repair the same object (as evidenced by location data and dispatch descriptions) during the expected operational life of the repairs, the repair metric of the first worker remains positive. The expected operation life of a given set of repairs is based on the object repaired. In some embodiments, an ML model is used to identify appropriate functional lifetimes of repairs based on historical examples.

The repair metric is determined by the cloud computing system 220 in terms of at least one of locations of the worker (e.g., traveling to the equipment), location of the equipment, time spent in proximity to the equipment, predetermined amount of time the equipment is expected to be operable (e.g., a day, a few months, a year, etc.) after repair, number of repairs, etc.

In another example, a repair metric relates to an average amount of time equipment is operable and in working condition after the worker visits the particular type of equipment the worker repaired. The repair metric is determined by the cloud computing system 220 in terms of at least one of a location of a smart radio 224a carried by the worker, time spent in proximity to the equipment, predetermined amount of time the equipment is expected to be operable (e.g., a day, a few months, a year, etc.) after repair, or location of the equipment. For example, if the particular type of equipment is operable for more than 60 days after the worker visited the equipment (to repair it), the repair metric of the worker with respect to the particular type of equipment is increased. If the equipment has broken within less than a week after the worker visited the equipment (to repair it), the repair metric of the worker with respect to the particular type of equipment is decreased. In embodiments, the machine learning system, illustrated and described in more detail with reference subsequent figures, is used to detect and track interactions (e.g., using features based on equipment types or defect reports as input data).

Another example of a repair metric for a worker relates to a ratio of the amount of time an equipment is operable after repair to a predetermined amount of time the equipment is expected to be operable (e.g., a day, a few months, a year, etc.) after repair. The predetermined amount of time changes with the type of equipment. For example, some industrial components wear out in a few days, while other components can last for years. After the worker repairs the particular type of equipment, the cloud computing system 220 counts until the predetermined amount of time for the particular type of equipment is reached. Once the predetermined amount of time is met, the equipment is considered correctly repaired, and the repair metric for the worker is incremented. If before the predetermined amount of time another worker is called to repair the same equipment, the repair metric for the worker is decremented.

In embodiments, equipment is assumed/considered repaired until the cloud computing system 220 is informed otherwise. In such embodiments, the worker does not need to wait to receive credit to their repair metric in cases where the predetermined amount of time for particular equipment is large (e.g., months or years).

The smart radio 224a can track not only the current location of the worker, but also send information received from other apparatuses (e.g., the smart radio 224b, the camera 228) to contribute to the recorded locational information (e.g., of employees 306 at the facility 300 shown by FIG. 3). Because the smart radios 224 are readable by the cloud computing system 220, locational records can be analyzed to determine how well the different workers and other device users are doing in performing various tasks. For example, if a worker is inspecting a particular vessel in a refinery, it may be necessary for them to spend an hour doing so for a high-quality job to be performed. However, if the locational data record reveals that the worker was physically at the vessel for only two minutes, it would be an indication of hasty or incomplete work. The cloud computing system 220 can therefore track a “engagement metric” of time spent at a task with respect to the time required to be spent for the task to be performed.

In embodiments, the cloud computing system tracks the path chosen by a worker from a current location to a destination as compared to a computed direct path for determining “route efficiency.” For example, tracking records for multiple workers going from a contractor's building at the site to another point within the site can be used to determine efficiency (e.g., patterns in foot traffic). In an example, the tracking reveals that a worker chooses a pathway that causes them to go back and forth to a location on the site that is long and goes around many interfering structures. The added distances reduce cost-effectiveness because of where the worker is actually walking. Traffic patterns and the “route efficiency” of a worker monitored and determined by the cloud computing system 220 based on positional data obtained from the smart radios 224 is used to improve the worker's efficiency at the facility.

In embodiments, the tracking is used to determine whether one or more workers are passing through or spending time in dangerous or restricted areas of the facility. The tracking is used by the cloud computing system 220 to determine a “risk metric” of each worker. For example, the risk metric is incremented when time logged by a smart radio that the worker is wearing in proximity to hazardous locations increases. In embodiments, the risk metric triggers an alarm at an appropriate juncture. In another example, the facility or the cloud computing system 220 establishes geofences around unsafe working areas. Geofencing is described in more detail with reference to FIG. 1. The risk metric is incremented when the position of the smart radio is determined to be within the geofence even though the worker is not supposed to be within the geofence for the particular task. In another example, the risk metric is incremented when a position of the smart radio and sensors mounted on particular equipment indicate that the equipment is faulty or unsafe to use, yet the worker is using the equipment instead of signaling for replacement equipment to be provided. The logged position and other data are also used to generate records to build an evidence profile to be used in accident situations.

In embodiments, the established geofencing described herein enables the smart radio 224a to receive alerts transmitted by the cloud computing system 220. The alerts are transmitted only to the apparatuses worn by workers having a risk metric above a threshold in this example. Based on locational records of the apparatuses connected to the local network 204, particular movable structures within the refinery may be moved such that a layout is configured to reduce the risk metric for workers in the refinery (e.g., where the cloud computing system 220 detects that employees are habitually forced to take longer walk paths in order to get around an obstructing barrier or structure). In embodiments, the ML, system is used to configure the layout to reduce the risk metric based on features extracted from coordinates of the geofencing, stored risk metrics, the locational records of the apparatuses connected to the local network 204, locations of the movable structures, or a combination thereof.

The cloud computing system 220 hosts the software functions to track operations, interactions, collaborations, and repair metrics (which are saved on one or more databases in the cloud) to determine performance metrics and time spent at different tasks and with different equipment and to generate work experience profiles of frontline workers based on interfacing between software suites of the cloud computing system 220 and the smart radio apparatuses 224, 232, smart cameras 228, 236, smartphone 244. The cloud computing system 220 is, in embodiments, configured by an administrating organization to enable workers to send and receive data to and from their smart devices. For example, functionality desired to create an interplay between the smart radios and other devices with software on the cloud computing system 220 is configured on the cloud by an organization interested in monitoring employees, transmitting alerts to these employees based on determinations made by a local server or the cloud computing system 220. Amazon Web Services (AWS), Microsoft Azure, and Google Cloud are widely used examples of a cloud platform, but others could be used instead.

Tracking of interactions, collaborations, and repair metrics is implemented in, for example, Scheduling Systems (SS), Field Data Management (FDS) systems, and/or Enterprise Resource Planning (ERP) software systems that are used to track and plan for the use of facility equipment and other resources. Manufacturing Management System (MMS) software is used to manage the production and logistics processes in manufacturing industries (e.g., for the purpose of reducing waste, improving maintenance processes and timing, etc.) Risk Based Inspection (RBI) software assists the facility using optimizing maintenance business processes to examine equipment and/or structures, and track interactions, collaborations, and repair metrics prior to and after a breakdown in equipment, detection of manufacturing failures, or detection of operational hazards (e.g., detection of gas leaks in the facility). The amount of time each worker logs at an interaction, collaboration, or other machine-defined activity with respect to different locations and different types of equipment is collected and used to update an “experience profile” of the worker on the cloud computing system 220 in real time. The repair metric and engagement metric for each worker with respect to different locations and different types of equipment is collected and used to update the experience profile of the worker on the cloud computing system 220 in real time.

### Experience Profile Features

FIG. 2B is a flow diagram illustrating an example process for generating a work experience profile using apparatuses 100, 242a, 242b, and communication networks 204, 208 for device tracking and geofencing, in accordance with one or more embodiments. The apparatus 100 is illustrated and described in more detail with reference to FIG. 1. The smart radios 224 and local networks 204, 208 are illustrated and described in more detail with reference to FIG. 2A. In embodiments, the process of FIG. 2B is performed by the cloud computing system 220 illustrated and described in more detail with reference to FIG. 2A. In embodiments, the process of FIG. 2A is performed by a computer system, for example, the example computer system illustrated and described in more detail with reference to subsequent figures. Particular entities, for example, the smart radios 224 or the local network 204, perform some or all of the steps of the process in embodiments. Likewise, embodiments can include different and/or additional steps, or perform the steps in different orders.

The experience profile that is automatically generated and updated by the cloud computing system 220 in real time includes multiple profile layers that store a record of work history of the worker. In embodiments, an HR employee record is created that lists what each worker was doing during a particular shift, at a particular location, and at a particular facility to build an evidence profile to be used in accident situations. A portion of the data in the experience profile can follow a worker when they change employment. A portion of the data remains with the employer.

In step 272, the cloud computing system 220 obtains locations and time logging information from multiple smart apparatuses (e.g., smart radios 224) located at a facility. An example facility 300 is illustrated and described in more detail with reference to FIG. 3. The locations describe movement of the multiple smart apparatuses with respect to the time logging information. For example, the cloud computing system 220 keeps track of shifts, types of equipment, and locations worked by each worker, and uses the information to develop the experience profile automatically for the worker, including formatting services. When the worker joins an employer or otherwise signs up for the service, relevant personal information is obtained by the cloud computing system 220 to establish payroll and other known employment particulars. The worker uses a smart radio 224a to engage with the cloud computing system 220 and works shifts for different positions. In embodiments, the cloud computing system 220 performs incident mapping based on the locations, time logging information, shifts, types of equipment, etc. For example, the cloud computing system 220 determines where the worker was with respect to an accident when the accident occurred and a timeline of the worker's locations before and after the accident. The incident mapping and the timeline is used to augment the risk metric described herein.

In step 276, the cloud computing system 220 determines interactions and collaborations for a worker based on the locations and the time logging information. Interactions and collaborations are described in more detail with reference to FIG. 2A. The interactions describe work performed by the worker with equipment of the facility (e.g., lathes, lifts, crane, etc.) The collaborations describe work performed by the worker with other workers of the facility. The cloud computing system 220 tracks the shifts worked, the amount of time spent with different equipment, interactions, collaborations, the relevant skills with respect to those shifts, etc.

The cloud computing system 220 generates a format for the experience profile of the worker based on the interactions and collaborations. The cloud computing system 220 generates the format by comparing the interactions and collaborations with respect to types of work performed by the worker with the equipment and the other workers. In an example, the cloud computing system 220 analyzes machine observations, such as location tracing of a smart radio a worker is carrying over a specific period of time cross-referenced with known locations of equipment.

In another example, the cloud computing system 220 analyzes contemporaneous video data that indicates equipment location. The machine observations used to denote interactions and collaborations are described in more detail with reference to FIG. 2A, for example, a start time, a duration of the activity, an end time, identities of the workers performing the activity, identity of the equipment(s) used by the workers, or a location of the activity.

The cloud computing system 220 assembles the information collected and identifies a format for the experience profile. The format is based on the information collected. Where a given worker has worked positions/locations with many different employers (as measured by threshold values), the format focuses on the time spent at the different types of work as opposed to individual employment. Where a worker has spent most of their time at a few specialized jobs (e.g., welding), the experience profile format is tailored toward employment that is related to that skill and deemphasizes unrelated employment (e.g., where the worker is a welder, time spent as a truck driver is not particularly relevant).

Where a given worker has worked on many (as measured by thresholds) shifts repeatedly with a given type of equipment, the experience profile format focuses on the worker's relationship with the given equipment. Based on the automated analysis, the system procedurally generates the experience profile content (e.g., descriptions of skills or attributes). The cloud computing system 220 includes multiple format templates that focus on emphasizing parts of the worker's experience profile or target jobs. Additional format templates are added based on evolving styles in various industries.

In embodiments, template styles are identified via the ML system. In step 280, the cloud computing system 220 extracts a feature vector from the interactions and collaborations using an ML model. Example measures that the cloud computing system 220 uses to denote interactions are described in more detail with reference to FIG. 2A, for example, a start time, a duration of the activity, an end time, identities of the workers performing the activity, identity of the equipment(s) used by the workers, or a location of the activity. The feature vector would be extracted from the measures. The feature vector describes types of work performed by the worker with the equipment and the other workers.

In step 284, the cloud computing system generates a format for an experience profile of the worker based on the feature vector using the ML model. The ML model is trained, based on stored experience profiles, to identify a format template for the format. The format includes multiple fields. To train the ML system, information from stored experience profiles is input into the ML system. The ML system interprets what appears on those stored experience profiles and correlates content of the worker's experience profile (e.g., time logged at particular experiences) to structure (e.g., how the experience profile is written). The ML system uses the worker's experience profile as compared to the data structures based on the training data to identify what elements of the worker's experience profile are the most relevant.

Similarly, the ML system identifies what information tends to not appear together and filters lower incidence data out. For example, when a worker has many (as measured by thresholds) verified or confirmed hours working with particular equipment, then experience at unskilled labor will tend not to appear on the worker's experience profile. In the example, the “lower incidence” data is the experience relating to unskilled work; however, the lower incidence varies based on the training data in the ML system. The relevant experience data that is not filtered out is based on the experience profile content that tends to appear together across the training set. The population of the training set is configured to be biased toward particular traits (e.g., hours spent using complex equipment) by including more instances of experience profiles having complex equipment listed than non-skilled work.

For example, the listed work experience in the experience profile includes 350 hours spent working on an assembly system for injection valves or 700 hours spent driving an industrial lift jack system having hydraulic rams with a capacity of 1000 tons. Such work experience is collated by the ML system from location data of the worker, sensor data of the equipment, shift data, etc. In embodiments, especially embodiments relying upon the ML system, a specific format template is not used. Rather, the ML system identifies a path in an artificial neural network where the generated experience profile content adheres to certain traits or rules that are template-like in nature according to that path of the neural network.

In step 288, the cloud computing system 220 generates the experience profile by filling the multiple fields of the format with information describing the interactions, the collaborations, repair metrics of the worker describing history of repairs to the equipment by the worker, and engagement metrics of the worker describing time spent by the worker working on the equipment. Repair metrics and engagement metrics are described in more detail with reference to FIG. 2A. The cloud computing system 220 automatically fills in fields/page space of the experience profile format identified. The data filled into the field space of the experience profile includes the specific number of hours that a worker has spent working with a particular type of equipment (e.g., 200 hours spent driving forklifts, 150 hours spent operating a lathe, etc.) Details used to fill in the format fields favor more recent experiences, interactions, and collaborations, or employment having stronger repair metrics and engagement metrics. In embodiments, the experience profile content is generated via procedural rules and predefined format template structures.

In embodiments, the cloud computing system 220 exports or publishes the experience profile to a user profile of a social or professional networking platform (e.g., such as LinkedIn™, Monster™, any other suitable social media or proprietary website, or a combination thereof). In embodiments, the cloud computing system 220 exports the experience profile in the form of a recommendation letter or reference package to past or prospective employers. The experience data enables a given worker to prove that they have a certain amount of experience with a given equipment platform.

Data pertaining to a given worker is organized into multiple tiers. In some embodiments, the tiers are structured into an individual basis, as connected to the contract the worker working, and as connected to their employer. Each of those tiers operates identity management within the cloud computing system 220. When a worker ceases to work for an employer or cease to work on a contract, their individual data (e.g., their training, what they did) continues to follow them through the system to the next employer/contract they are attached to. Data is conserved in escalating tiers such that individual data is stored to the contract level and stored to the employer level.

Conversely, data pertaining to the contract (e.g., performance data, hours worked, accident mapping) stays with the contract tier. Similarly, data pertaining to the employer tier (e.g., the same as contract data across multiple contracts) remains with the employer.

Users are part of a global directory of login profiles to the smart radios (or other interface platforms). Regardless of which employer/facility/project/other group delineation the user is associated with, the user logs in to the smart radio using the same login identity. The global directory enables traceability of otherwise transient workers. Each user has a seamless experience in multiple facilities and need not worry about multiple passwords per group delineation.

FIG. 3 is a drawing illustrating an example facility 300 using apparatuses and communication networks for device tracking and geofencing, in accordance with one or more embodiments. For example, the facility 300 is a refinery, a manufacturing facility, a construction site, etc. An example apparatus 100 is illustrated and described in more detail with reference to FIG. 1. The communication technology shown by FIG. 3 is implemented using components of the example computer system illustrated and described in more detail with reference to subsequent figures.

Multiple differently and strategically placed wireless antennas 374 are used to receive signals from an Internet source (e.g., a fiber backhaul at the facility), or a mobile system (e.g., a truck 302). The wireless antennas 374 are similar to or the same as the wireless antenna 174 illustrated and described in more detail with reference to FIG. 1. The truck 302, in embodiments, includes the edge kit 172 illustrated and described in more detail with reference to FIG. 1. The strategically placed wireless antennas 374 repeat the signals received and sent from the edge kit 172 such that a private cellular network (e.g., the local network 204 illustrated and described in more detail with reference to FIG. 2A) is made available to multiple workers 306. Each worker carries or wears a cellular-enabled smart radio. The smart radio is implemented using the apparatus 100 illustrated and described in more detail with reference to FIG. 1. As described in more detail with reference to FIG. 1 and FIG. 2A, a position of the smart radio is continually tracked during a work shift.

In implementations, a stationary, temporary, or permanently installed cellular (e.g., LTE or 5G) source (e.g., edge kit 172) is used that obtains network access through a fiber or cable backhaul. In embodiments, a satellite or other Internet source is embodied into hand-carried or other mobile systems (e.g., a bag, box, or other portable arrangement). FIG. 3 shows that multiple wireless antennas 374 are installed at various locations throughout the facility. Where the edge kit 172 is located at a location near a facility fiber backhaul, the communication system in the facility 300 uses multiple omnidirectional Multi-Band Outdoor (MBO) antennas as shown. Where the Internet source is instead, located near an edge of the facility 300, as is often the case, the communication system uses one or more directional wireless antennas to improve the coverage in terms of bandwidth. Alternatively, where the edge kit is in a mobile vehicle, for example, truck 302, the antennas' directional configuration would be picked depending on whether the vehicle would ultimately be located at a central or boundary location.

In embodiments where a backhaul arrangement is installed at the facility 300, the edge kit 172 is directly connected to an existing fiber router, cable router, or any other source of Internet at the facility. In embodiments, the wireless antennas 374 are deployed at a location in which the apparatus 100 (e.g., a smart radio) is to be used. For example, the wireless antennas 374 are omnidirectional, directional, or semi-directional depending on the intended coverage area. In embodiments, the wireless antennas 374 support a local cellular network (e.g., the local network 204 illustrated and described in more detail with reference to FIG. 2A). In embodiments, the local network is a private LTE network (e.g., based on 4G or 5G). In more specific embodiments, the network is a Band 48 CBRS local network. The frequency range for Band 48 extends from 3550 MHz to 3700 MHz and is executed using TDD as the duplex mode. The private LTE wireless communication device 105 (illustrated and described in more detail with reference to FIG. 1) is configured to operate in the private network created, for example, configured to accommodate Band 48 CBRS in the frequency range for Band 48 (again, from 3550 MHz to 3700 MHz) and accommodates TDD. Thus, channels within the preferred range are used for different types of communications between the cloud and the local network.

### Location-Based Features

As described herein, smart radios are configured with location estimating capabilities and are used within a facility or worksite for which geofences are defined. A geofence refers to a virtual perimeter for a real-world geographic area, such as a portion of a facility or worksite. A smart radio includes location-aware devices (e.g., position tracking component 125, position estimating component 123) that inform of the location of the smart radio at various times. Embodiments described herein relate to location-based features for smart radios or smart apparatuses. Location-based features described herein use location data for smart radios to provide improved functionality. In some embodiments, a location of a smart radio (e.g., a position estimate) is assumed to be representative of a location of a worker using or associated with the smart radio. As such, embodiments described herein apply location data for smart radios to perform various functions for workers of a facility or worksite.

### Responder-Targeted Communications

Some example scenarios that require radio communication between workers are area-specific, or relevant to a given area of a facility. As one example, a local machine anomaly in a given area of a facility is transmitted to each worker in a given geofence. The use of geofences to define various areas within a facility or worksite provides a means for defining area-specificity of various machinery.

Auditory notifications to workers located in a given area is needed to handle area-specific scenarios relevant to the given area. In some examples, the communication is needed at least to transmit alerts to notify the workers of the area-specific scenario and to convey instructions to handle and/or remedy the scenario.

According to some embodiments, locations of smart radios are monitored (e.g., by cloud computing system 220) such that at a point in time, each smart radio located in a specific geofenced area is identified. FIG. 4 illustrates an example of a worksite 400 that includes a plurality of geofenced areas 402, with smart radios 405 being located within the geofenced areas 402.

In some embodiments, an alert, notification, communication, and/or the like is transmitted to each smart radio 405 that is located within a geofenced area 402 (e.g., 402C) responsive to a selection or indication of the geofenced area 402. A smart radio 405, an administrator smart radio (e.g., a smart radio assigned to an administrator), or the cloud computing system 220 is configured to enable user selection of one of the plurality of geofenced areas 402 (e.g., 402C). For example, a map display of the worksite 400 and the plurality of geofenced areas 402 is provided. With the user selection of a geofenced area 402 and a location for each smart radio 405, a set of smart radios 405 located within the geofenced area 402 is identified. An alert, notification, communication, and/or the like is then transmitted to the identified smart radios 405.

### Equipment Location Monitoring

Embodiments described herein relate to mobile equipment or tool tracking via smart radios as triangulation references. In this context, mobile equipment refers to worksite or facility industrial equipment (e.g., heavy machinery, precision tools, construction vehicles). According to example embodiments, a location of a mobile equipment is continuously monitored based on repeated triangulation from multiple smart radios located near the mobile equipment. Improvements to the operation and usage of the mobile equipment are made based on analyzing the locations of the mobile equipment throughout a facility or worksite. Locations of the mobile equipment are reported to owners of the mobile equipment or entities that own, operate, and/or maintain the mobile equipment. Mobile equipment whose location is tracked includes vehicles, tools used and shared by workers in different facility locations, toolkits and toolboxes, manufactured and/or packaged products, and/or the like. Generally, mobile equipment is movable between different locations within the facility or worksite at different points in time.

In some embodiments, a tag device is physically attached to a mobile equipment so that the location of the mobile equipment is monitored. A computer system (e.g., example computer system, cloud computing system 220, a smart radio, an administrator smart radio) receives tag detection data from at least three smart radios based on the smart radios communicating with the tag device. Each instance of tag detection data received from a smart radio includes a distance to the tag device and a location of the smart radio.

In some embodiments, the tag detection data is received from smart radios owned or associated with different entities. That is, different smart radios that are not necessarily associated with the same given entity (e.g., a company with which various operators at the worksite are employed) as a given mobile equipment are used to track the given mobile equipment. As such, ubiquity of smart radios that are capable or allowed to track a given mobile equipment (via the tag device) is increased regardless of ownership or association with particular entities.

In some embodiments, the tag device is an AirTag™ device. In some embodiments, the tag device is associated with a detection range. The tag device is detectable via wireless communication by other devices, including smart radios, located within the detection range of the tag device. For example, a smart radio detects the tag device via Wi-Fi, Bluetooth, BLE, near-field communications, cellular communications, and/or the like. In some embodiments, a smart radio that is located within the detection range of the tag device detects the tag device, determines a distance between the smart radio and the tag device, and provides the tag detection data to the computer system.

From the tag detection data, the computer system determines a location of the tag device, which is representative of the location of the mobile equipment. In particular, the location of the mobile equipment is triangulated from the known locations of multiple smart radios and the respective distances to the tag device, using the tag detection data.

Thus, the computer system determines the location of the mobile equipment and is configured to continuously monitor the location of the mobile equipment as additional tag detection data is obtained over time.

In some embodiments, the determined location of the mobile equipment is indicated to the entity with which the mobile equipment is associated (e.g., an owner, a user of the mobile equipment, etc.). As discussed, in some examples, the location of the mobile equipment is determined based on triangulation of the tag device by different smart radios owned by different entities. If a mobile equipment location is determined via multiple entities, the mobile equipment location is only reported to the relevant entity, such that mobile equipment locations are not insecurely shared across entities.

In some embodiments, mobile equipment location is determined and tracked according to privacy layers or groups that are defined. For example, a tag for a mobile equipment is detected and tracked by a first group of entities (or smart radios assigned to a first privacy layer), and the determined location is reported to a smaller group of entities (or devices assigned to a second privacy layer).

Various monitoring operations are performed based on the locations of the mobile equipment that are determined over time. In some embodiments, a usage level for the mobile equipment is automatically classified based on different locations of the mobile equipment over time. For example, a mobile equipment having frequent changes in location within a window of time (e.g., different locations that are at least a threshold distance away from each other) is classified at a high usage level compared to a mobile equipment that remains in approximately the same location for the window of time. In some embodiments, certain mobile equipment classified with high usage levels are indicated and identified to maintenance workers such that usage-related failures or faults can be preemptively identified.

In some embodiments, a resting or storage location for the mobile equipment is determined based on the monitoring of the mobile equipment location. For example, an average spatial location is determined from the locations of the mobile equipment over time. A storage location based on the average spatial location is then indicated in a recommendation provided or displayed to an administrator or other entity that manages the facility or worksite.

In some embodiments, locations of multiple mobile equipment are monitored so that a particular mobile equipment is recommended for use to a worker during certain events or scenarios. As another example, for a worker assigned with a maintenance task at a location within a facility, one or more maintenance toolkits shared among workers and located near the location are recommended to the worker for use.

Accordingly, embodiments described herein provide local detection and monitoring of mobile equipment locations. Facility operation efficiency is improved based on the monitoring of mobile equipment locations and analysis of different mobile equipment locations.

The use of tags further enables the system to identify whether a given worker is carrying a given tool. Even with a single smart radio as a reference point, if a distance measurement remains static, and short (e.g., 3 feet or less) while the smart radio is tracked as moving, it is likely the worker is carrying the tool. Using the information that the worker is holding a particular tool is relevant to the sort of notifications or alerts presented to that worker.

Notifications Associated with Nearby Equipment

Turning now to FIG. 5, a flow diagram is provided. The flow diagram illustrates an example process for auditory notifications associated with nearby equipment (e.g., a “proximate machine”). In some examples, the illustrated process is performed to minimize resource usage when communicating with workers in a facility about local scenarios and events. In some embodiments, the illustrated process is performed by a cloud computing system 220 (e.g., shown in FIG. 2A). In some embodiments, the illustrated process is performed by a computer system, for example, the example computer system illustrated and described in more detail with reference to subsequent figures. Particular entities, for example, the smart radios (e.g., smart radios 405, smart radios 224), perform some or all of the steps of the process in some embodiments. Likewise, some embodiments include different and/or additional steps, or perform the steps in different orders.

In step 502, a plurality of smart apparatuses (e.g., smart radios 405, smart radios 224) are carried by a worker and are location tracked. The worker is logged in to the smart radio. In some embodiments, the worker's role, work experience, and available tools are tracked by the smart radio. Available tools refer to tools that the system is aware that the worker is carrying or are available within a threshold distance. In some embodiments, the smart apparatuses are identified based on obtaining location and time logging information from multiple smart apparatuses. Locations of the multiple apparatuses are mapped to a plurality of geofences that define areas within a worksite, such as the example geofenced areas illustrated in FIG. 4.

In step 504, a machine located somewhere within an operations facility is monitored by a sensor suite that identifies a status thereof. Non-limiting illustrative examples of such machines may include a smelter, a boiler, a mixer, a fabricator, a turbine, an engine, or manufacturing equipment. The machine includes a baseline or specification running condition. The sensor suite monitors the machine for anomalous and/or harmful conditions. In step 506, the sensor suite detects an issue with the machine that would call for maintenance or repairs. For example, a given machine is low on lubricant, or another machine has become stuck or jammed. In some embodiments, the sensor suite reports the issue to the cloud computing system 220. In some embodiments, the issue is stored on a local register/memory.

In step 508, the given smart apparatus passes by the machine that had detected an issue. The detection of the smart apparatus in the vicinity of the machine may vary by embodiment or implements multiple embodiments. An illustrative example of a detection method includes location tracking (ex: as described herein) cross-referenced with a known location of the machine by the cloud computing system or the smart apparatus. A further example makes use of short-range machine-to-machine communication techniques, such as Bluetooth or BLE. A BLE communication is a beacon that is receivable by any smart apparatus within range (adjustable by signal strength). A Bluetooth communication (e.g., or other suitable machine-to-machine protocol such as ZigBee) operates based on a pairing relationship between the smart apparatus and wireless transceiver apparatus of the machine. The relevant range is predetermined and based on settings that correspond to the method of detection. Short-range transmissions vary transmission power and location detection makes use of geofences or threshold distances.

In some embodiments, the ranges are based on a disambiguation range for the relevant machine. Disambiguation considerations are facility-specific and based on other neighboring machines of a similar type and sight lines thereto. Would a worker passing by be aware that an auditory notification referred to the relevant machine? Can the worker see the machine from the triggering distance? Are there other machines in the vicinity that the worker would confuse for the relevant machine?

For longer range embodiments, multiple devices may be present within range at the same time (e.g., as identified by a geofence). In such cases, notifications may be emitted by multiple smart apparatuses simultaneously to each user within a geofence or each user within a geofence who is not also within a threshold distance of another worker (e.g., to prevent redundant notification).

In step 510, the system determines whether to notify the worker via auditory notification of the issue with the machine. In some embodiments, the notification occurs for each smart apparatus entering the predetermined range of the machine with the detected issue. In other embodiments, the system automatically evaluates one or more conditions prior to reporting. Example conditions include: does the worker holding the smart apparatus have a relevant role or work experience to address the particular issue that the sensor suite detected on the machine? Is the worker holding the necessary tool or set of tools that are required to address the issue? If not, are those tools within a threshold range and obtainable? Is the worker currently tasked with a priority task or a more important duty than addressing the machine's issue? Is the machine's issue an emergency?

To evaluate these conditions the system maintains a set of specifications that pertain to issues that the machine may experience. The specifications include flags related to the roles, skills, or personnel required to address each potential issue, and a priority level of the issue. These specifications are cross-referenced with the worker profile logged into the relevant, proximate smart apparatus and/or central dispatch records for each worker.

In step 512, the smart apparatus emits an auditory notification to the worker carrying the smart apparatus. The auditory notification includes enough information for the worker to identify the relevant machine and the issue experienced by the machine (e.g., “the generator on your left needs oil”). In some embodiments, the notification further includes an instruction of where to find relevant tools or materials to address the issue (e.g., “oil is found in the cabinet opposite the generator”). The auditory notifications provide a speaker for the machine that wouldn't otherwise be able to communicate the issue to a worker passing by.

Communicating the issue to the worker while they are in the area achieves efficiencies in addressing issues while a worker is already in the area as opposed to requiring a worker sent from a central dispatch location to address the issue. Additionally, the speaker for the machine improves efficiency of a “wandering repairman” worker role. The wandering repairman need merely approach relevant machines rather than manually inspect the machines. If no notification is emitted by the worker's smart apparatus, the sensor suite did not detect an issue for that worker to repair or improve.

In some embodiments, additional constraints or thresholds are considered when selecting the subset of smart radios. For example, smart radios are assigned to different workers with different roles, role levels, profiles, and/or the like. Smart radios whose assigned worker satisfies a threshold role level, a role/profile requirement, and/or the like are considered for the selection of the subset. In some embodiments, the additional constraints (e.g., threshold role level, role requirement) are determined based on the relevant event or scenario that prompted the process.

In step 514, it is contemplated that the first passing worker may not address the issue; thus, the machine issue resets or persists until addressed. In this manner, the next worker who passes by may receive the same auditory notification. Workers are notified until someone fixes the issue with the machine. When a worker engages with the machine they will report in a dispatch system to reset the sensor suite. In some embodiments, the dispatch system report or sensor suite reset occurs automatically based on proximity or new sensor suite readings.

In some embodiments, selection of smart radios is further based on experience profiles of the workers associated with the smart radios. For example, workers with an average response time less than a threshold are automatically selected for the first responder subset. Use of response time metrics in worker experience profiles conserves some time that would be spent detecting response activities on the smart radios and determining (and ordering) response times.

### Computer Embodiment

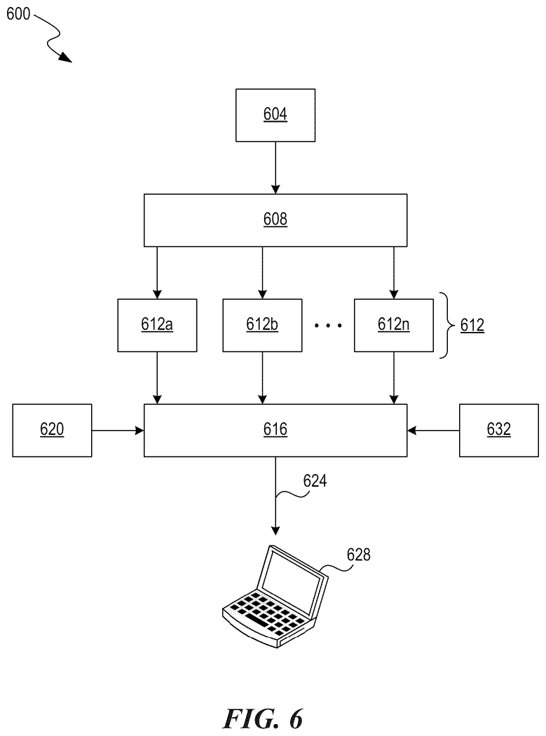

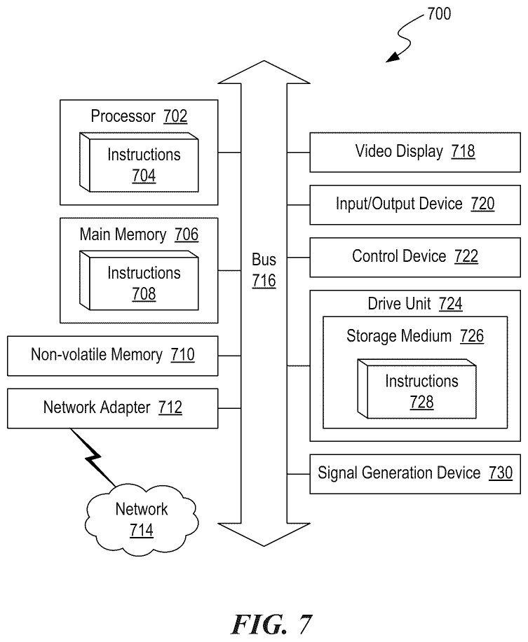

FIG. 6 is a block diagram illustrating an example ML system 600, in accordance with one or more embodiments. The ML system 600 is implemented using components of the example computer system 700 illustrated and described in more detail with reference to FIG. 7. For example, portions of the ML system 600 are implemented on the apparatus 100 illustrated and described in more detail with reference to FIG. 1, or on the cloud computing system 220 illustrated and described in more detail with reference to FIG. 2A. Likewise, different embodiments of the ML system 600 include different and/or additional components and are connected in different ways. The ML system 600 is sometimes referred to as a ML module.

The ML system 600 includes a feature extraction module 608 implemented using components of the example computer system 700 illustrated and described in more detail with reference to FIG. 7. In some embodiments, the feature extraction module 608 extracts a feature vector 612 from input data 604. For example, the input data 604 includes location parameters measured by device implemented in accordance with the architecture 100 illustrated and described in more detail with reference to FIG. 1. The feature vector 612 includes features 612a, 612b, . . . , 612n. The feature extraction module 608 reduces the redundancy in the input data 604, for example, repetitive data values, to transform the input data 604 into the reduced set of features 612, for example, features 612a, 612b, . . . , 612n. The feature vector 612 contains the relevant information from the input data 604, such that events or data value thresholds of interest are identified by the ML model 616 by using a reduced representation. In some example embodiments, the following dimensionality reduction techniques are used by the feature extraction module 608: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In alternate embodiments, the ML model 616 performs deep learning (also known as deep structured learning or hierarchical learning) directly on the input data 604 to learn data representations, as opposed to using task-specific algorithms. In deep learning, no explicit feature extraction is performed; the features 612 are implicitly extracted by the ML system 600. For example, the ML model 616 uses a cascade of multiple layers of nonlinear processing units for implicit feature extraction and transformation. Each successive layer uses the output from the previous layer as input. The ML model 616 thus learns in supervised (e.g., classification) and/or unsupervised (e.g., pattern analysis) modes. The ML model 616 learns multiple levels of representations that correspond to different levels of abstraction, wherein the different levels form a hierarchy of concepts. The multiple levels of representation configure the ML model 616 to differentiate features of interest from background features.

In alternative example embodiments, the ML model 616, for example, in the form of a CNN generates the output 624, without the need for feature extraction, directly from the input data 604. The output 624 is provided to the computer device 628, the cloud computing system 220, or the apparatus 100. The computer device 628 is a server, computer, tablet, smartphone, smart speaker (e.g., the speaker 632), etc., implemented using components of the example computer system 700 illustrated and described in more detail with reference to FIG. 7. In some embodiments, the steps performed by the ML system 600 are stored in memory on the computer device 628 for execution. In other embodiments, the output 624 is displayed on the apparatus 100 or electronic displays of the cloud computing system 60.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In embodiments, the ML model 616 is a CNN that includes both convolutional layers and max pooling layers. For example, the architecture of the ML model 616 is “fully convolutional,” which means that variable sized sensor data vectors are fed into it. For convolutional layers, the ML model 616 specifies a kernel size, a stride of the convolution, and an amount of zero padding applied to the input of that layer. For the pooling layers, the model 616 specifies the kernel size and stride of the pooling.

In some embodiments, the ML system 600 trains the ML model 616, based on the training data 620, to correlate the feature vector 612 to expected outputs in the training data 620. As part of the training of the ML model 616, the ML system 600 forms a training set of features and training labels by identifying a positive training set of features that have been determined to have a desired property in question, and, in some embodiments, forms a negative training set of features that lack the property in question.

The ML system 600 applies ML techniques to train the ML model 616, that when applied to the feature vector 612, output indications of whether the feature vector 612 has an associated desired property or properties, such as a probability that the feature vector 612 has a particular Boolean property, or an estimated value of a scalar property. In embodiments, the ML system 600 further applies dimensionality reduction (e.g., via linear discriminant analysis (LDA), PCA, or the like) to reduce the amount of data in the feature vector 612 to a smaller, more representative set of data.

In embodiments, the ML system 600 uses supervised ML to train the ML model 616, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 632 is formed of additional features, other than those in the training data 620, which have already been determined to have or to lack the property in question. The ML system 600 applies the trained ML model 616 to the features of the validation set 632 to quantify the accuracy of the ML model 616. Common metrics applied in accuracy measurement include Precision and Recall, where Precision refers to a number of results the ML model 616 correctly predicted out of the total it predicted, and Recall is a number of results the ML model 616 correctly predicted out of the total number of features that had the desired property in question. In some embodiments, the ML system 600 iteratively retrains the ML model 616 until the occurrence of a stopping condition, such as the accuracy measurement indication that the ML model 616 is sufficiently accurate, or a number of training rounds having taken place. In embodiments, the validation set 632 includes data corresponding to confirmed locations, dates, times, activities, or combinations thereof. This allows the detected values to be validated using the validation set 632. The validation set 632 is generated based on the analysis to be performed.

FIG. 7 is a block diagram illustrating an example computer system, in accordance with one or more embodiments. Components of the example computer system 700 are used to implement the smart radios 224, the cloud computing system 220, and the smart camera 236 illustrated and described in more detail with reference to FIG. 2A. In some embodiments, components of the example computer system 700 are used to implement the ML system environment 200 illustrated and described in more detail with reference to FIG. 2A. At least some operations described herein are implemented on the computer system 700.

The computer system 700 includes one or more central processing units (“processors”) 702, main memory 706, non-volatile memory 710, network adapters 712 (e.g., network interface), video displays 718, input/output devices 720, control devices 722 (e.g., keyboard and pointing devices), drive units 724 including a storage medium 726, and a signal generation device 730 that are communicatively connected to a bus 716. The bus 716 is illustrated as an abstraction that represents one or more physical buses and/or point-to-point connections that are connected by appropriate bridges, adapters, or controllers. In embodiments, the bus 716, includes a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an IEEE standard 1394 bus (also referred to as “Firewire”).

In embodiments, the computer system 700 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 700.

While the main memory 706, non-volatile memory 710, and storage medium 726 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 728. The term “machine-readable medium” and “storage medium” shall also be taken to include any medium that is capable of storing, encoding, or carrying a set of instructions for execution by the computer system 700.

In general, the routines executed to implement the embodiments of the disclosure are implemented as part of an operating system or a specific application, component, program, object, module, or sequence of instructions (collectively referred to as “computer programs”). The computer programs typically include one or more instructions (e.g., instructions 704, 708, 728) set at various times in various memory and storage devices in a computer device. When read and executed by the one or more processors 702, the instruction(s) cause the computer system 700 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 710, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 712 enables the computer system 700 to mediate data in a network 714 with an entity that is external to the computer system 700 through any communication protocol supported by the computer system 700 and the external entity. In embodiments, the network adapter 712 includes a network adapter card, a wireless network interface card, a router, an access point, a wireless router, a switch, a multilayer switch, a protocol converter, a gateway, a bridge, a bridge router, a hub, a digital media receiver, and/or a repeater.

In embodiments, the network adapter 712 includes a firewall that governs and/or manages permission to access proxy data in a computer network and tracks varying levels of trust between different machines and/or applications. In embodiments, the firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall additionally manages and/or has access to an access control list that details permissions including the access and operation rights of an object by an individual, a machine, and/or an application, and the circumstances under which the permission rights stand.

In embodiments, the functions performed in the processes and methods are implemented in differing order. Furthermore, the outlined steps and operations are only provided as examples. For example, some of the steps and operations are optional, combined into fewer steps and operations, or expanded into additional steps and operations without detracting from the essence of the disclosed embodiments.

In embodiments, the techniques introduced here are implemented by programmable circuitry (e.g., one or more microprocessors), software and/or firmware, special-purpose hardwired (i.e., non-programmable) circuitry, or a combination of such forms. In embodiments, special-purpose circuitry is in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. It will be appreciated that the same thing can be said in more than one way. One will recognize that “memory” is one form of a “storage” and that the terms are on occasion used interchangeably.

Consequently, alternative language and synonyms are used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

1. An apparatus comprising:
a wireless transceiver;
a speaker;
a processor; and
a memory including instructions that when executed by the processor cause the apparatus to receive status data of proximate machines via the wireless transceiver and emit the status data audibly via the speaker as a user of the apparatus passes within range of the proximate machines.

2. The apparatus of claim 1, comprising a display screen configured to display images and text stored in the memory.

3. The apparatus of claim 1, comprising a user-input device configured to:
receive input; and
transmit the input to the processor.

4. The apparatus of claim 1, further comprising:
a position tracking device configured to track a location of the apparatus and implement the location to determine whether the apparatus is proximate to the proximate machines.

5. The apparatus of claim 4, wherein the processor is configured to:
monitor location data received from the position tracking device; and
store the location data either locally or on a cloud computing system.

6. The apparatus of claim 1, wherein the apparatus is configured to determine whether the apparatus is proximate to the proximate machines based on a communication range and transmit power of the wireless transceiver.

7. The apparatus of claim 1, further including a logged in user, the logged in user having a work experience profile, the instructions when executed further limit receipt or emission of the status data based on whether the work experience profile includes an association with the proximate machines.

8. A system comprising:
a wireless transceiver configured to receive status data of a first machine within a predetermined adjacency range;
a location sensor that is configured to output data from which a range of a user to the first machine is derivable; and
a speaker configured to emit the status data audibly via the speaker as the user of the system passes within the predetermined adjacency range of the first machine.

9. The system of claim 8 further comprising:
a sensor suite affixed to the first machine and configured to measure operating parameters of the first machine; and
a transmitter affixed to the first machine and configured to broadcast the status data.

10. The system of claim 8, wherein the predetermined adjacency range is associated with a machine-to-machine protocol broadcast distance.

11. The system of claim 8, wherein the output data from which a range to the first machine is derivable is a pairing range of a machine-to-machine protocol broadcast distance.

12. The system of claim 8, wherein the location sensor is a global positioning system sensor or a network strength range measurement sensor that aids in triangulation of a user location and the predetermined adjacency range is based on a geofence positioned around the first machine.

13. The system of claim 8, further comprising:
a user profile including an associated machines profile; and
wherein receipt of the status data only occurs where the first machine is present on the associate machines profile.

14. The system of claim 8, wherein the status data is received via a communicative connection to a host server or a communicative connection to the first machine directly.

15. A method comprising:
determining that a mobile device possessed by a user is within a predetermined adjacency range of a first machine based on location data from which a range of a user to the first machine is derivable;
receiving, via a wireless transceiver, status data of the first machine within the predetermined adjacency range; and
emitting, via a speaker of the mobile device, the status data audibly as the user of the mobile device passes within the predetermined adjacency range of the first machine.

16. The method of claim 15 further comprising:
measuring, via a sensor suite affixed to the first machine, operating parameters of the first machine; and
transmitting, by the first machine, the status data.

17. The method of claim 15, wherein the predetermined adjacency range is associated with a machine-to-machine protocol broadcast distance.

18. The method of claim 15, wherein an output data from which a range to the first machine is derivable is a pairing range of a machine-to-machine protocol broadcast distance.

19. The method of claim 15, wherein the location data is generated by a global positioning system sensor or a network strength range measurement sensor that aids in triangulation of a user location and the predetermined adjacency range is based on a geofence positioned around the first machine.

20. The method of claim 15, further comprising:
logging into the mobile device with a user profile including an associated machines profile; and
wherein receipt of the status data only occurs where the first machine is present on the associated machines profile.

21. The method of claim 15, wherein the status data is received via a communicative connection to a host server or a communicative connection to the first machine directly.
